(19) United States
(12) Patent Application Publication
(10) Pub. No.: US 2006/0182479 A1
(43) Pub. Date: Aug. 17, 2006

(54) Image forming apparatus

(75) Inventor: Yasuhiro Miyake, Osaka-shi (JP)

Correspondence Address: CASELLA & HESPOS, 274 MADISON AVENUE, NEW YORK, NY, 10016, US

(73) Assignee: Kyocera Mita Corporation, Osaka-shi (JP)

(21) Appl. No.: 11/353,377

(22) Filed: Feb. 13, 2006

(30) Foreign Application Priority Data
Feb. 14, 2005 (JP) 2005-036518

(51) Int. Cl. G03G 15/00

(52) U.S. Cl. 399/400

(57) ABSTRACT

A printer includes: a transferring device for transferring a toner image to paper; a fixing device for fixing the toner image onto the paper; a conveyance guide for guiding the paper separated from the transferring device to the fixing device, the conveyance guide being electrically insulated; and a conductive member which is grounded and protrudes from the conveyance guide so as to come in contact with the paper guided by the conveyance guide on the surface opposite to a surface bearing a transferred image.

### BACKGROUND OF THE INVENTION

1. Field of the Invention

The present invention relates to an image forming apparatus, such as a copying machine, a printer, a facsimile machine, a composite machine. More particularly, it relates to an image forming apparatus comprising a conveyance guide made of an electrically insulative member for guiding paper separated from a transferring device to a fixing device.

2. Description of the Related Art

Generally, on a conveyance path through which paper after being formed an image thereon is conveyed to a fixing device, toner particles are electrically pulled onto the paper by applying electric charges onto the paper by a transferring device. Further, if the conveyance of paper to the fixing device is not stable, defects such as wrinkling and bending of the paper occurs. Therefore, in order to stabilize the paper conveyance, a conveyance passage adapted to convey the paper along a plastic conveyance guide including a plastic frame is usually set. When being conveyed, the paper may be electrostatically charged by frictions between the paper and the conveyance guide. Consequently, defects such as image distortion are likely to occur.

According to Japanese Unexamined Patent Publication No. HEI 9-96968, the electric potential of a charge removing device provided on the downstream of a transferring device is made to have the same polarity as transfer bias voltage near the front end and the rear end of the paper. Thereby, an image defect such as wearing and blurring caused by bouncing of the rear end of the paper is prevented from occurring maintaining the separability of the front end of the paper. Further, according to Japanese Unexamined Patent Publication No. HEI 5-100593, a charge removing device provided on the downstream of a separating device applies voltage to paper to prevent an image defect.

However, the image forming apparatuses disclosed in Japanese Unexamined Patent Publication Nos. HEI 9-96968 and HEI 5-100593 require a complicated charge removing device. Mounting such complicated charge removing device increases the cost. Furthermore, Japanese Unexamined Patent Publication Nos. HEI 9-96968 and HEI 5-100593 are only to eliminate image distortion due to charges onto the paper when the paper is separated by applying an electricity to the paper. Consequently, defects of image distortion due to frictions when the paper rasps on the plastic conveyance guide with rippling and scattering of toner by charges caused by sharp changes in the paper conveyance direction cannot be eliminated.

In these cases, there exists a method for reducing the frictional resistance occurring when the paper rasps on the conveyance guide. The method is to optimize the conveyance path in such a way that the paper is conveyed slightly above the conveyance guide. However, this method causes the conveyance to be unstabilized depending upon the kind, size and use environment of paper, and requires much time for assessment. Further, there exists a method of applying mirror grinding to the plastic conveyance guide. However, it causes a problem of requiring maintenance of a mold.

### SUMMARY OF THE INVENTION

The present invention has worked out in view of the problems described above, and its object is to provide an image forming apparatus having a simple configuration for eliminating an image distortion caused by frictions occurred between the paper and the conveyance guide.

According to an aspect of the present invention, an image forming apparatus comprises a transferring device for transferring a toner image to paper; a fixing device for fixing the toner image onto the paper; a conveyance guide for guiding the paper separated from the transferring device to the fixing device, the conveyance guide being electrically insulated; and a conductive member which is grounded and protrudes from the conveyance guide so as to come in contact with the paper guided by the conveyance guide on a surface opposite to a surface bearing a transferred image.

With this construction, the conductive member which is grounded and protrudes from the conveyance guide so as to come in contact with the paper guided by the conveyance guide on a surface opposite to a surface bearing a transferred image is provided. The image forming apparatus is provided with the simple construction that the conductive member comes in contact with the surface of the paper on that no toner is transferred, the frictional resistance is reduced, and an image distortion caused by the friction between the paper and the conveyance guide is also reduced assuredly. Further, the image forming apparatus does not have a complicated construction and an increased size as the conventional image forming apparatuses. Accordingly, the operability and the cost performance can be improved.

These and other objects, features, aspects, and advantages of the present invention will become more apparent from the following detailed description of the preferred embodiments/examples with reference to the accompanying drawings.

### BRIEF DESCRIPTION OF THE DRAWING

FIG. 1 is a cross-sectional view showing a schematic construction of a printer according to an embodiment of the invention.

FIG. 2 is an enlarged cross-sectional view showing a part of a second conveyance passage.

FIG. 3 is a perspective view showing a part of a lower half portion of the second conveyance passage viewed from above.

FIGS. 4A and 4B show a step of a mounting operation of a coil spring in the second conveyance passage, that is, a state before mounting. FIG. 4A is a plan view, and FIG. 4B is a cross-sectional view taken along the line 4B-4B in FIG. 4A.

FIGS. 5A and 5B show a step of the mounting operation of the coil spring in the second conveyance passage, that is, a state during mounting. FIG. 5A is a plan view, and FIG. 5B is a cross-sectional view taken along the line 5B-5B in FIG. 5A.

FIGS. 6A and 6B show a step of the mounting operation of the coil spring in the second conveyance passage, that is, a state after mounting. FIG. 6A is a plan view, and FIG. 6B is a cross-sectional view taken along the line 6B-6B in FIG. 6A.

### DETAILED DESCRIPTION OF THE PREFERRED EMBODIMENTS

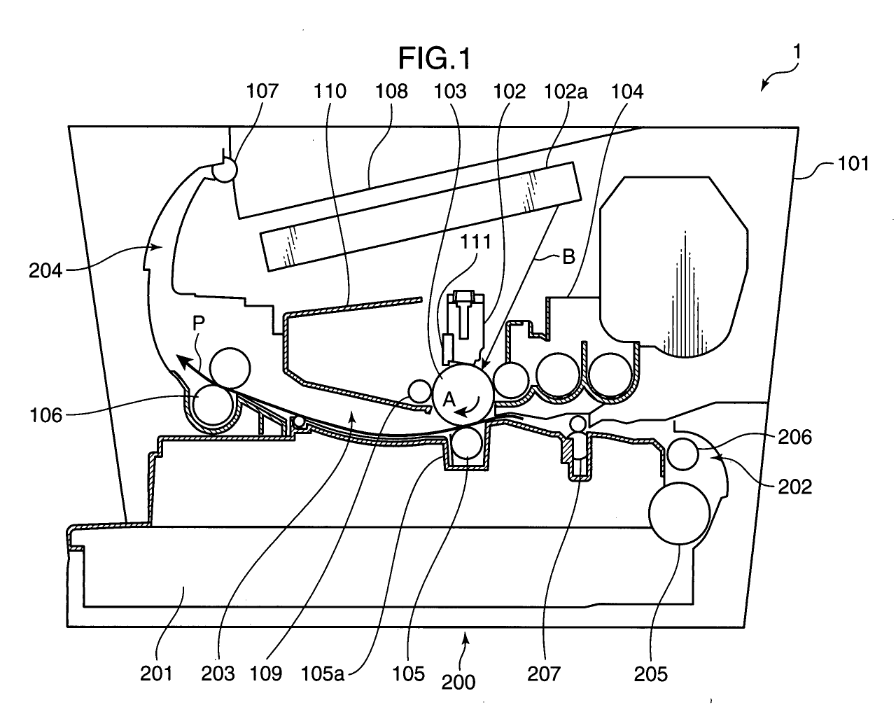

FIG. 1 is a cross-sectional view showing a schematic configuration of a printer according to an embodiment of the present invention.

As shown in FIG. 1, in a box-shaped main body 1 of the printer 1, that is one of image forming apparatuses, a charging device 102 charges uniformly a peripheral surface of a photoconductor drum 103 which rotates in a direction A as shown in FIG. 1. An exposing portion 102a irradiates a laser light ray B based on an image data to the peripheral surface of the photoconductor drum 103 to form an electrostatic latent image. A developing device 104 supplies toner to the electrostatic latent image formed on the photoconductor drum 103. Thereby, a toner image is formed on the peripheral surface of the photoconductor drum 103.

On the other hand, a paper sheet P is conveyed from a paper feeding mechanism 200 to the photo conductor drum 103. A transferring roller (a transferring device) 105 transfers the toner image formed on the surface of the photoconductor drum 103 to a surface (transferred surface) of the paper sheet P. After the transfer of the toner image is completed, a cleaning device 110 including a cleaning roller 109 removes the toner left on the photoconductor drum 103. Then, a charge removing device 111 removes a residual electric charge left on the photoconductor drum 103.

Then, the paper sheet P which is separated from the photoconductor 103 by a separating device 105a is conveyed to a pair of fixing rollers (fixing device) 106. The toner image is fixed on the paper sheet P by the fixing roller pair, and then the paper sheet P is directly (or after being turned over by an unillustrated switch back device to be executed a double-face printing) discharged to a discharging portion 108 by a discharging roller 107.

A paper feeding mechanism 200 includes a paper feeding cassette 201 which is detachably mounted on the printer main body 101, and stores a number of paper sheets P being stacked. This paper feeding mechanism 200 also includes a pickup roller 205 for picking up a stored paper sheet P. The paper feeding mechanism 200 also includes a paper feeding roller 206 for feeding a paper sheet P picked up by the pickup roller 205 to a conveyance passage each picking. At the upstream side (on the right hand side in FIG. 1) of the photoconductor drum 103 in the conveyance passage, a pair of registration rollers 207 for holding the paper sheet P transferred from the paper feeding roller 206 is mounted.

The conveyance passage further includes a first conveyance passage 202 for conveying the paper sheet P from the paper feeding cassette 201 to the photoconductor 103, a second conveyance passage 203 for conveying the paper sheet P from the photoconductor drum 103 to the fixing roller pair 106, and a third conveyance passage 204 for conveying the paper sheet P from the fixing roller pair 106 to the discharging roller 107.

The first conveyance passage 202 stands almost vertically on the right hand side of the printer main body 101 as shown in FIG. 1. At the middle height position of the printer main body 101, the first conveyance passage 202 extends horizontally toward the left hand side in FIG. 1 and reaches the photoconductor drum 103. The third conveyance passage 204 is located on the opposite side of the first conveyance passage 202, in other words, it is located at the left hand side in FIG. 1. It stands almost vertically from the fixing roller pair 106 located at the middle height position of the printer main body 101. The second conveyance passage 203 includes a coil spring 203d. The second conveyance passage 203 extends almost horizontally at the middle height position of the printer main body 101 from the transferring roller 105 to the fixing roller pair 106 and connects the first conveyance passage 202 and the third conveyance passage 204.

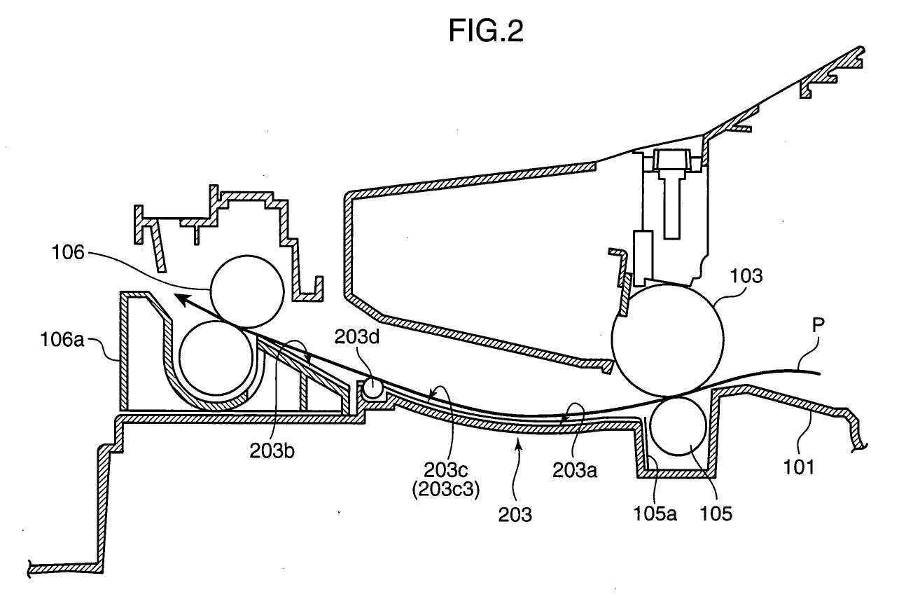

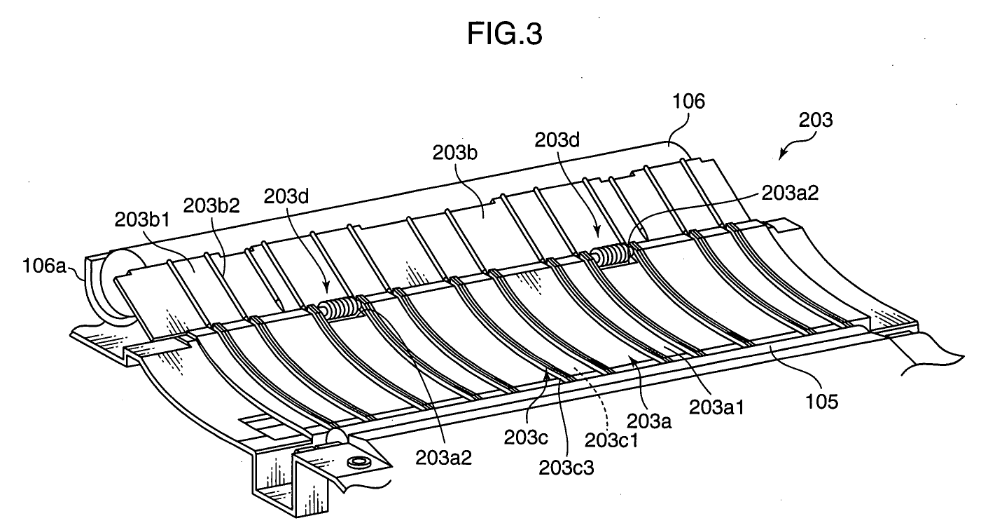

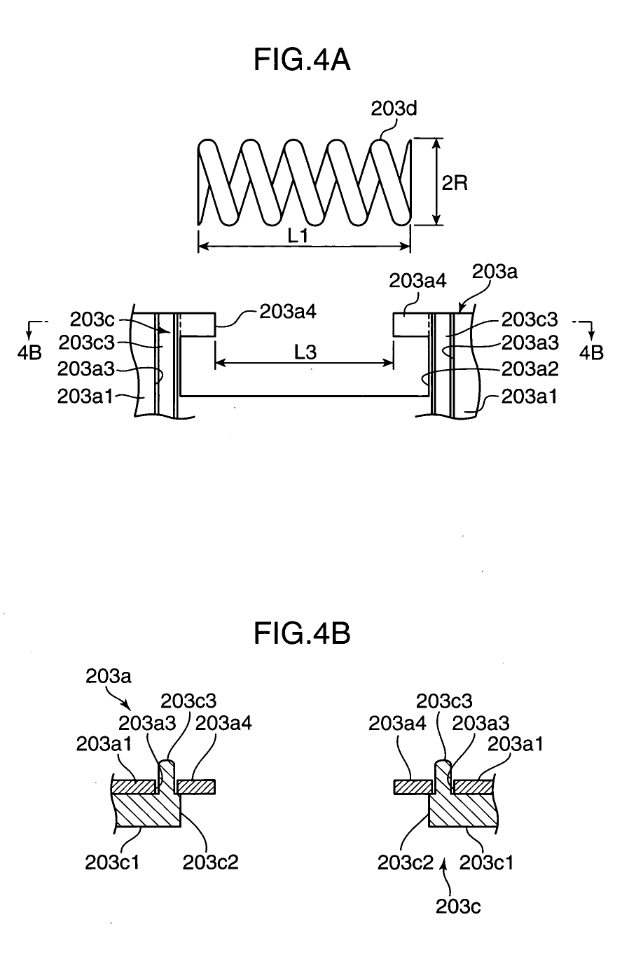

FIG. 2 is an enlarged cross-sectional view showing a part of the second conveyance passage. FIG. 3 is a perspective view showing a part of a lower half portion of the second conveyance passage viewed from above. FIGS. 4A to 6B show a mounting operation of the coil spring to the second conveyance passage. FIGS. 4A, 5A, and 6A are plan views, respectively, and FIGS. 4B, 5B, and 6B are cross-sectional views taken along the lines 4B-4B, 5B-5B, and 6B-6B in FIGS. 4A, 5A, and 6B, respectively.

As shown in FIGS. 2 and 3, the second conveyance passage 203 includes a conveyance guide 203c made of an electrically insulative material, which is a part of the printer main body 101, a conductive plate 203a made of an electrical material extending along the conveyance guide 203c, a secondary conveyance guide 203b mounted on a supporting structure 106a for supporting the fixing roller pair 106, and a coil spring (a conductive member) 203d made by an electrically conductive wire and rotatably supported at the downstream end of the conductive plate 203a.

The conveyance guide 203c is arranged at an upstream side (right side in FIG. 2, forward side in FIG. 3) of a portion between the transferring roller 105 and the fixing roller pair 106. The conveyance guide 203c includes a specified number of ribs 203c3 having a predetermined height and extending perpendicularly to a width direction. The ribs 203c3 are formed on a curved area 203c1 having a larger rising inclination at the downstream side (left side in FIG. 2, back side in FIG. 3), and they are aligned in the width direction at certain intervals (direction perpendicular to the drawing surface of FIG. 2, horizontal direction in FIG. 3). In the downstream end of the conveyance guide 203c, two notches 203c2 for respectively accommodating coil springs 203d between two pairs of ribs 203c3 located at positions which are almost symmetrical in the width direction.

The conductive plate 203a is mounted on the conveyance guide 203c. The conductive plate 203a includes a curved portion 203a1 which is formed so as to correspond to the upper surface of the curved area 203c1. The curved portion 203a1 has notches 203a2 corresponding to the notches 203c2, and slits 203a3 corresponding to the ribs 203c3. Then, the paper sheet P is conveyed on the ribs 203c3 protruded from the slits 203a3 so that the paper sheet P can be conveyed along the curved portion 203a1 without coming in contact with the conductive plate 203a.

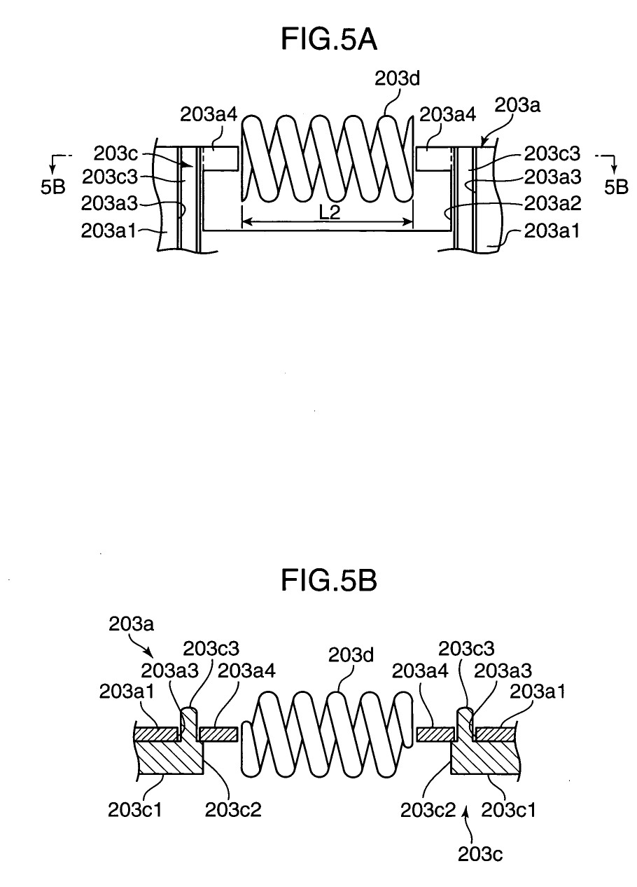

Further, on the opposite inner walls at the forward end of the notch 203a2 of the conductive plate 203a, as shown in FIGS. 4A and 4B, for example, are formed bosses 203a4 which are formed by not cutting specified portions at the downstream end of the conductive plate 203a when forming the notch 203a2. In some case, the bosses 203a4 may be formed by curling specified portions. The bosses 203a4 face each other having a length L3 therebetween. The length L3 is shorter than a free length L1 of the coil spring 203d but longer than a length L2 in a compression state (refer to FIG. 5A). At further upstream side from the bosses 203a4, the notch 203a2 is formed so as to be longer than the free length L1 of the coil spring 203d and slightly larger than a diameter R of the coil spring 203d.

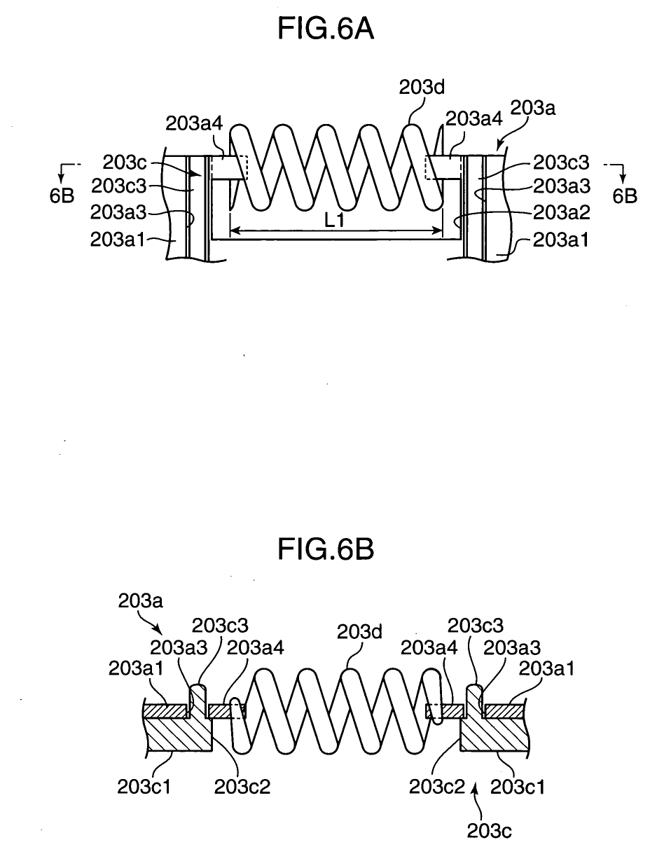

As shown in FIGS. 5A and 5B, the coil spring 203d is compressed, and the coil spring 203d is positioned so that the both ends of the coil spring agree with the bosses 203a4 in the notches 203a2. The conductive member 203a is placed on the conveyance guide 203c so that the notch 203a2 corresponds to the notch 203c2. Then, as shown in FIGS. 6A and 6B, the compression of the coil spring 203d is released so that the coil spring 203d is rough fittingly mounted on the bosses 203a4 by a resilient restoration force. In the state where the coil spring 203d is mounted, the coil spring 203d is rotatable and slightly protrudes over the rib 203c3 of the conveyance guide 203c. This protruded portion constitutes the highest part in the second conveyance passage 203 for paper sheet P.

In this way, the coil spring 203d mounted as described above is operable to come in contact with the paper sheet P conveyed along the ribs 203c3 of the conveyance guide 203c. Thereby, static electricity which is caused by the above-mentioned frictions and charged on the paper sheet P can be removed efficiently. Specifically, the static electricity is grounded at a predetermined portion after having been passed through the coil spring 203d and the conductive plate 203a (having the bosses 203a4) from the paper sheet P, and is consequently removed. The coil spring 203d makes rolling contact with the paper sheet P to thereby ensure smooth contact. Consequently, less friction occurs between the paper sheet P and the ribs 203c3 of the conveyance guide 203c.

The secondary conveyance guide 203b is mounted on the downstream side of the section between the transferring roller 105 and the fixing roller pair 106. The secondary conveyance guide 203b includes a rising surface 203b1 having a constant inclination steeper than that of the conductive plate 203a and extending from the position where a height is one stage lower than the downstream end of the conductive plate 203a toward the fixing roller pair 106. On the rising surface 203b1, a specified number of ribs 203b2 having a predetermined height and extending perpendicularly with respect to the width direction is formed at certain intervals. Then, the paper sheet P is guided by the ribs 203b2 so as to enter the fixing roller pair 106.

Next, the paper sheet conveyance in the operation of the printer is described.

First, as shown in FIG. 1, in this printer 1, the pickup roller 205 picks up paper sheets P from the paper feeding cassette 201 of the paper feeding mechanism 200. Then, the paper sheets P which have been picked up are separated from one another by the paper feeding roller 206, and conveyed one after another to the first conveyance passage 202. The registration roller pair 207 temporarily holds the paper sheet P conveyed to the first conveyance passage 202 to thereby keep the paper sheet P in a standby state.

The paper sheet P is held in the standby state until a toner image is formed on the surface of the photoconductor drum 103. After the standby state is released, the paper sheet P is conveyed toward the photoconductor drum 103. Then, the transferring roller 105 located at the opposed position with respect to the photoconductor drum 103 transfers the toner image formed on the surface of the photoconductor drum 103 to the surface (transferring surface) of the paper sheet P.

Next, as shown in FIG. 2, the paper sheet P is separated from the photoconductor drum 103 by a separating device 105a and conveyed to the fixing roller pair 106 through the second conveyance passage 203. Since the paper sheet P has electrostatic charges, the paper sheet P is electrostatically attached to the curved surface 203a1 of the conductive plate 203a. Therefore, the paper sheet P is transferred downwardly near an outlet of the transferring roller 105. The rear surface of the conveyed paper sheet P (opposite side of the transferred surface) comes in contact with the ribs 203c3 of the conveyance guide 203c, and the paper sheet P is guided by the ribs 203c3 of the conveyance guide 203c. Thereby, the paper sheet P is conveyed almost horizontally while it is rippled a bit. During this conveyance, frictions between the paper sheet P and the ribs 203c3 of the conveyance guide 203c cause the paper sheet P to have more charges.

When the forward end of the paper sheet P conveyed almost horizontally along the ribs 203c3 of the conveyance guide 203c reaches the coil spring 203d, the paper sheet P makes the coil spring 203d rotate and runs on the coil spring 203d. Since the coil spring 203d is grounded through the conductive plate 203a on which the coil spring 203d is rotatably mounted, the coil spring 203d removes the static electricity being charged on the paper sheet P efficiently when it comes in contact with the paper sheet P.

The paper sheet P from which the static electricity has been removed by the contact with the coil spring 203d goes over the coil spring 203d while rotating it. Then, the paper sheet P is guided by the ribs 203b2 of the secondary conveyance guide 203b, and reaches the fixing roller pair 106.

After the toner image is fixed on the paper sheet P by this fixing roller pair 106, the paper sheet P passes through the third conveyance passage 204 and is directly (or after being turned over by an unillustrated switch back portion to execute a double-face printing) discharged to the discharge portion 108 by the discharging roller 107.

As described above, according to the embodiment, the printer 1 is provided with the coil spring 203d which protrudes from the conveyance guide 203c and rotatably comes in contact with the back surface of the paper sheet P guided by the ribs 203c3 of the conveyance guide 203c. The construction is simple because the coil spring 203d rotatably comes in contact with the back surface of the paper sheet P conveyed by the ribs 203c3 of the conveyance guide 203c, the friction between the paper sheet P and the rib 203c3 of the conveyance guide 203c is reduced, and image distortion caused by the friction is also reduced assuredly. Further, since the configuration of the apparatus is not complicated and do not grow in size as can be seen in conventional image forming apparatuses, the operability and the cost performance are improved.

Further, According to the embodiment, the coil spring 203d is mounted as a conductive member on the downstream end of the rib 203c3 of the conveyance guide 203c, namely, it is mounted on the side of the fixing roller pair 106. However, the coil spring 203d may be mounted on a desirable position in the section between the transferring roller 105 and the fixing roller pair 106. However, it should be noted that it is rather effective to mount the coil spring 203d on the side of the fixing roller pair 106 in order to keep image distortion from occurring due to friction between the paper sheet P and the ribs 203c3 of the conveyance guide 203c.

Furthermore, instead of using the coil spring 203d, a small roller made of a conductive material may be used for a conductive member. Further, a resilient piece made of a conductive material which comes in contact with the paper sheet P may also be used. However, as described above, in the case where the coil spring 203d is used, a conductive member can be easily mounted using an elasticity of a spring. Thereby, the apparatus can be downsized and its operability improves.

Furthermore, according to the embodiment, two coil springs 203d are mounted symmetrically in a width direction with respect to the conveyance guide 203c. However, at least one coil spring 203d may be mounted on a center with respect to the width direction of the conveyance guide 203c. However, it should be noted that in the case of mounting two coil springs 203d symmetrically in a width direction of the conveyance guide 203c, the conveyance of the paper sheet P is stabilized and uneven contact of the paper sheet P with the rib 203c3 of the conveyance guide 203c is avoided, which thus eliminates the possibility of increasing the friction due to an uneven contact.

Furthermore, according to the embodiment, the bosses 203a4 provided at the left and right sides of the notch 203a2 of the conductive plate 203a penetrates through the coil spring 203d. However, it may be appreciated to separately provide a shaft made of conductive material on the conveyance guide 203c, and mount the coil spring 203d rotatably the shaft.

Furthermore, according to the embodiment, the coil spring 203d is grounded through the conductive plate 203a. However, in the case where the resilient piece is used as the conductive member, the conductive piece may be directly grounded.

Furthermore, the above embodiment is described in relation to a printer. However, the present invention can be surely applied to a copying machine, a facsimile machine, a composite machine and other image forming apparatuses.

As described above, the present invention relates to an image forming apparatus comprising: a transferring device for transferring a toner image to paper; a fixing device for fixing the toner image onto the paper; a conveyance guide for guiding the paper separated from the transferring device to the fixing device, the conveyance guide being electrically insulative; and a conductive member which is grounded and protrudes from the conveyance guide so as to come in contact with the paper guided by the conveyance guide on a surface opposite to a surface bearing a transferred image.

According to the image forming apparatus of the present invention, the conductive member which is grounded and protrudes from the conveyance guide so as to come in contact with the paper guided by the conveyance guide on the surface opposite to a surface bearing a transferred image is provided. Thereby, the image forming apparatus has the simple construction that the conductive member comes in contact with the surface of the paper being conveyed along the conveyance guide, the surface not bearing toner. Image distortion due to frictions between the paper sheet and the conveyance guide is reduced assuredly. Further, since the construction of the apparatus is not complicated and do not grow in size as the conventional image forming apparatuses, the operability and the cost performance are improved.

Meanwhile, the amount of electrostatic charges onto the paper sheet caused by frictions between the paper sheet and the conveyance guide increases as the conveyance distance of the paper sheet increases. Further, since the paper conveying direction is sharply changed before the fixing, the contact pressure of the paper on the conveyance guide rises, which thus increase the amount of electrostatic charges onto the paper. Accordingly, removing electrostatic charges from the paper between the transferring device and the fixing device causes the likelihood that the paper repeatedly does contact with and rift from the conveyance guide at further downstream of the portion where the electrostatic charge is removed, or the paper conveying direction sharply changes, and the paper consequently has charges.

In view thereof, the conductive member is mounted on the downstream end of the conveyance guide, that is, a position near the fixing device, all the electrostatic charges can be removed at one time at the portion where the paper is maximally charged by frictions of the paper with the conveyance guide, and the paper conveying direction sharply changes. Thereby, an image distortion caused by frictions of the paper with the conveyance guide and by the change in the paper conveying direction can be surely prevented.

Further, it is preferable that the conductive member is a rotatable member which is rotatably mounted on the conveyance guide.

According to this construction, frictions of the paper with the conveyance guide becomes smaller, which thus assures smooth contact. Accordingly, image distortion caused by frictions of paper with the conveyance guide can be surely prevented.

Further, a conductive plate extends along the conveyance guide, and the conductive member is rotatably supported at the downstream end of the conductive plate.

According to this construction, the paper which is electrostatically charged by frictions between the paper and the conveyance guide is surely grounded through the conductive plate. Thereby, image distortion caused by frictions between the paper and the conveyance guide can be surely prevented.

Further, it may be preferable that the rotatable member is a coil spring.

According to this construction, the conductive member can be easily mounted using the elasticity of a spring. Thereby, the apparatus can be downsized and its operability is improved.

It will be seen that if only one conductive member is mounted at an extreme side end position in the width direction in the conveyance guide, the paper conveyance is unstable, in the worst case, only one side portion of the paper is likely to come into contact with the conveyance guide and thus cause increased friction resistance. Accordingly, providing a plurality of conductive members symmetrically in the width direction of the conveyance guide can assure stabilized conveyance of paper, and assure reduced frictional resistance between the paper and the conveyance guide. Thus, image distortion due to the friction of paper can be prevented.

This application is based on patent application No. 2005-36518 filed in Japan, the contents of which are hereby incorporated by references.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds are therefore intended to embraced by the claims.

What is claimed is:

1. An image forming apparatus comprising:
a transferring device for transferring a toner image to paper;
a fixing device for fixing the toner image onto the paper;
a conveyance guide for guiding the paper separated from the transferring device to the fixing device, the conveyance guide being electrically insulated; and
a conductive member which is grounded and protrudes from the conveyance guide so as to come in contact with the paper guided by the conveyance guide on a surface opposite to a surface bearing a transferred image.

2. An image forming apparatus according to claim 1, wherein the conductive member is provided near the fixing device.

3. An image forming apparatus according to claim 1, wherein the conductive member is a rotatable member which is rotatably mounted on the conveyance guide.

4. An image forming apparatus according to claim 2, wherein the conductive member is a rotatable member which is rotatably mounted on the conveyance guide.

5. An image forming apparatus according to claim 3, further comprising a conductive plate extending along the conveyance guide, wherein the conductive member is rotatably supported at the downstream end of the conductive plate.

6. An image forming apparatus according to claim 4, further comprising a conductive plate extending along the conveyance guide, wherein the conductive member is rotatably supported at the downstream end of the conductive plate.

7. An image forming apparatus according to claim 3, wherein the conductive member is a coil spring.

8. An image forming apparatus according to claim 4, wherein the conductive member is a coil spring.

9. An image forming apparatus according to claim 5, wherein the conductive member is a coil spring.

10. An image forming apparatus according to claim 1, wherein a plurality of conductive members are mounted symmetrically in a width direction with respect to the conveyance guide.

11. An image forming apparatus according to claim 2, wherein a plurality of conductive members are mounted symmetrically in a width direction with respect to the conveyance guide.

12. An image forming apparatus according to claim 3, wherein a plurality of conductive members are mounted symmetrically in a width direction with respect to the conveyance guide.

13. An image forming apparatus according to claim 4, wherein a plurality of conductive members are mounted symmetrically in a width direction with respect to the conveyance guide.

14. An image forming apparatus according to claim 5, wherein a plurality of conductive member are mounted symmetrically in a width direction with respect to the conveyance guide.

15. An image forming apparatus according to claim 7, wherein a plurality of conductive members are mounted symmetrically in a width direction with respect to the conveyance guide.
